(19) United States
(12) Patent Application Publication
(10) Pub. No.: US 2015/0278706 A1
(43) Pub. Date: Oct. 1, 2015

(54) Method, Predictive Analytics System, and Computer Program Product for Performing Online and Offline Learning

(71) Applicant: Telefonaktiebolaget L M Ericsson (publ), Stockholm (SE)

(72) Inventors: Subramanian SHIVASHANKAR, Ponni Nagar Chennai (IN); Manoj Prasanna Kumar, West Mambalam Chennai (IN); Shubham Verma, Murgan Kalyan Mandapam (IN)

(73) Assignee: Telefonaktiebolaget L M Ericsson (publ), Stockholm (SE)

(21) Appl. No.: 14/226,149

(22) Filed: Mar. 26, 2014

(51) Int. Cl. G06N 99/00; G06N 5/04

(52) U.S. Cl. CPC G06N 99/005; G06N 5/04

(57) ABSTRACT

A method, predictive analytics system, and computer program product for performing online and offline learning is provided. The system obtains a first function used to generate a prediction, where the first function was generated from a first set of training data. The system sets a second function as being equal to the first function. The system further collects during an interval a second set of training data. At the end of the interval, the predictive analytics system updates the first function based on the second set of training data. While the first function is being updated, a third set of training data is collected. The system updates the second function while the first function is being updated. The updating of the second function is based on the third set of training data, where the third set of training data is more recent than the second set of training data.

### TECHNICAL FIELD

This disclosure relates to a method, predictive analytics system, and computer program product for performing online and offline learning.

### BACKGROUND

Predictive analytics has been used in contexts such as customer relationship management (CRM) systems, targeted advertisement systems (TAS), campaign design systems, and churn prediction systems. For example, a CRM system can use predictive analytics to generate a churn score and influence score of a customer from various input parameters. The scores may gauge how likely a customer will unsubscribe or otherwise leave a particular service. The scores may aid a call center agent in retaining the customer. Another example where predictive analytics is used is at a network operations center (NOC). There, a field engineer may monitor a set of key performance indicator (KPI) values to predict whether an alarm will occur. The prediction can be used to proactively predict alarms and initiate preventive measures. The predictive analytics described above may be performed in real time. Systems that implement real time predictive analytics may continuously update predictions and models as new input values are received.

Predictive analytics can rely on functions (e.g., predictive models) that generate a prediction based on values of input parameters. Such functions may be generated from a machine learning technique that recognizes pattern in training data, which may include values of input parameters and (for supervised and semi-supervised learning) values of an output parameter, which may also be referred to as labels. As an example of online learning, a model may be generated “on the fly,” as training data become available. For example, an online learning technique may receive real-time values from a NOC environment, make a prediction about whether an alarm will occur, subsequently receive feedback as to whether the alarm actually occurred, and then adjust a function used to make the prediction. In cases of offline learning, a set training data may already be available. For example, an offline learning technique may receive a set of recorded input values from the NOC environment in the past two months and recorded indications of whether an alarm occurred in that time period. The offline learning may then generate a model that relates the input parameter values to the output parameter value.

### SUMMARY

The present disclosure relates to creating a system that integrates online learning and offline learning to enhance a predictive analytics system's ability make accurate predictions.

In general, learning a function (e.g., model) for predictive analytics has been done either completely online or completely offline. In online learning, a function may be generated over many iterations and a long time period, as training data becomes available. Initial iterations of an online function generated by the online learning may be based on only a few values of training data, and thus have low accuracy. Offline learning may be performed in a context in which the training data is available all at once. Thus, the first iteration of an offline function generated by offline learning may be more accurate than the first iteration of an online function. However, offline learning may not be as dynamic as online learning. For instance, although the training data for offline learning may be available all at once, the data may have a certain amount of latency compared to real-time data. If the real-time data exhibits a sudden change in trend, the offline function may not reflect that change in trend. Further, offline learning may be limited in the size of training data that it can handle. In cases where the amount of training data is very large, using offline learning to process that data to generate the function may be unfeasible. Moreover, the generation of the offline function itself takes time, which may introduce additional latency into the offline learning.

The latency and accuracy of predictive analytics may be improved by combining offline learning and online learning. In some instances, offline learning may first generate an offline function. This offline function may “bootstrap” the online function by setting the online function equal to the offline function. The online learning may thus begin in a state that is more accurate compared to a state without bootstrapping.

The combination of online learning and offline learning may further be enhanced by continuing both the online learning and offline learning after a bootstrapped state or any other state. More particularly, after an online function is bootstrapped, it may be periodically updated with the offline learning process as more training data (e.g., “real-time” training data) becomes available. Because the offline learning itself takes time, however, an online learning process may occur simultaneously. In some cases, the online learning process may update the online function using fewer values of the training data and less complex computations compared to offline learning. Online learning allows the online function to generate predictions that capture recent trends in training data while the offline learning is being performed. Using fewer values of the training data and using less complex computations may, however, lead to inaccuracies in the updated online function. Thus, after the offline learning is complete, the updated offline function may then replace the online function. The simultaneous offline learning and online learning may then be repeated for a desired number of times. In some cases, the interval at which offline learning is repeated may be based on prediction confidence or any other performance criteria of the online function. For instance, the interval could be reduced by a constant value, or can be reduced exponentially as a function of increase in confidence with respect to predictions.

In one aspect of the present disclosure, a method of updating functions used for making predictions is provided. The method is performed by a predictive analytics system. The predictive analytics system obtains a first function used to generate a prediction of an output parameter from an input parameter, where the first function was generated from a first set of training data. The predictive analytics system sets a second function as being equal to the first function, where the second function is used for generating a prediction. The system further collects during an interval a second set of training data. At the end of the interval, the predictive analytics system updates the first function based on the second set of training data. While the first function is being updated, a third set of training data is collected. The predictive analytics system updates the second function while the first function is being updated. The updating of the second function is based on the third set of training data, where the third set of training data is more recent than the second set of training data.

In some instances, the method includes setting the second function equal to the first function after the first function is updated.

In some instances, the method comprises updating the second function during the interval and setting the function as being equal to a snapshot of the second function at the end of the interval. The first function is updated after being set equal to the snapshot of the second function.

In some instances, updating the second function comprises performing a plurality of updates corresponding to different time instances. Each of the plurality of updates may be based on only a most recent value in the third set of training data.

In some instances, updating the second function comprises adding to the second function another function that is based on one or more most recent values in the third set of training data.

In some instances, collecting the set of input values comprises i) receiving a first value of training data during the interval; ii) determining a first confidence value identifying a confidence with which the first function can predict an output value based on the received first value; iii) determining whether the first confidence value is less than a second confidence value corresponding to a second value that is in the second set of training data; and iv) in response to determining that the first confidence value is less than the second confidence value, replacing the second value with the first value in the second set of training data.

In some instances, the first function defines a boundary between one or more classes, and wherein determining the first confidence value comprises determining a distance between the first value and the boundary.

In some instances, the second confidence value that is compared with the first confidence value is a highest confidence value for values in the second set of training data.

In some instances, the duration of the interval is dynamically determined.

In some instances, the duration of the interval equals a time taken for a storage size of the collected set of values to equal or exceed a buffer size allocated on a storage device to store the collected set of values.

In some instances, collecting of the second set of training data is performed by a plurality of processors, and wherein the allocated buffer size is shared by the plurality of processors.

In some instances, updating the first function comprises calculating values of parameters of a machine learning algorithm. In such instances, the method further comprises storing the values of the parameters in a storage device and performing another update of the first function using the stored values.

Features, objects, and advantages of the present disclosure will become apparent to those skilled in the art by reading the following detailed description where references will be made to the appended figures.

### BRIEF DESCRIPTION OF THE DRAWINGS

FIG. 1 illustrates a telecommunications system that includes a predictive analytics system.

FIG. 2 illustrates an example predictive analytics system.

FIG. 3 illustrates a timing diagram according to embodiments of the present disclosure.

FIGS. 4-6 illustrate flow diagrams according to embodiments of the present disclosure.

FIG. 7 illustrates a data sampling unit and offline function generator according to one embodiment of the present disclosure.

FIG. 8 illustrates experimental data according to one embodiment of the present disclosure.

FIG. 9 illustrates a server according to one embodiment of the present disclosure.

### DETAILED DESCRIPTION

The present disclosure is concerned with predictive analytics, and more specifically with updating the functions (e.g., models) used to make predictions. The updating may include performing both online learning and offline learning. As an example, the offline learning may initially generate with a set of training data an offline function, which may be used to bootstrap an online function. After the bootstrapping, the offline learning may be performed periodically to update the online function as more training data becomes available. More specifically, the offline learning may take a snapshot of the online function and set an offline function to be equal to the snapshot. Offline learning may then be performed on the offline function, so that the online function remains available to make predictions.

While offline learning is taking place, online learning also occurs to update the online function. In certain cases, online learning occurs continuously (e.g., for each new value of training data received), while offline learning occurs periodically (e.g., after a sufficient number of values of training data have been received). The online learning may thus capture a changing trend in the training data that may be missed by the offline learning process. In some cases, each time that an online learning process takes place, it may use fewer values of training data and a less complex computation compared to the offline learning process. When the offline learning finishes updating the offline function, the online function may be updated by being set equal to the updated offline function.

Further, as discussed in more detail below, offline learning may sometimes have an upper limit on how much training data it can process. In such situations, the training data collected by the predictive analytics system may be sampled to generate a set of training data with a size that can be processed using offline learning. The sampling may select training data having a lowest confidence among all of the received values of training data. For example, if the offline function is used to classify a vector of input values (an input vector) into a particular category, the training data with the lowest confidence may include data having input vectors that are the hardest to categorize. Including such training data in the offline learning may allow the offline function to be able to make more nuanced distinction between classes of input vectors.

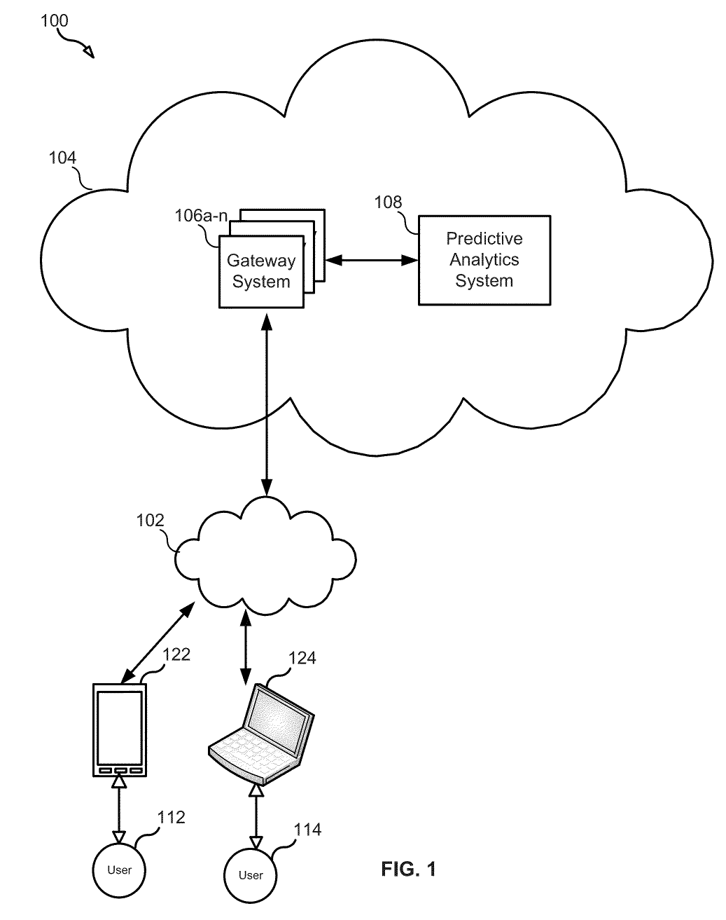

FIG. 1 illustrates an example telecommunications system 100 that may integrate a predictive analytics system. The predictive analytics system 108 may, for example, predict whether a user will unsubscribe from a service of the telecommunications system 100, whether an alarm condition will occur in the system 100, whether a user will adopt a recommendation of a product, event, or service, or any other prediction.

The predictive analytics system may be supplied with data by one or more gateways 106a-n of the telecommunications system. The one or more gateways may be, for instance, a gateway of a core network (e.g., LTE SAE network) that receives data from an access network 102 (e.g., an eNB). The data may include data generated by users' 112/114 client devices 122/124 (e.g., search terms generated for a search engine or user profile data), data generated by the access network 102, data generated by the core network 104, or any other data. In some instances, the data may be used by the predictive analytics system to make a prediction, to train an online or offline function, or both. For example, the predictive analytics system may make a prediction with the data, receive additional data that provides feedback on whether the prediction was correct, and then adjust the online or offline function based on all of the data.

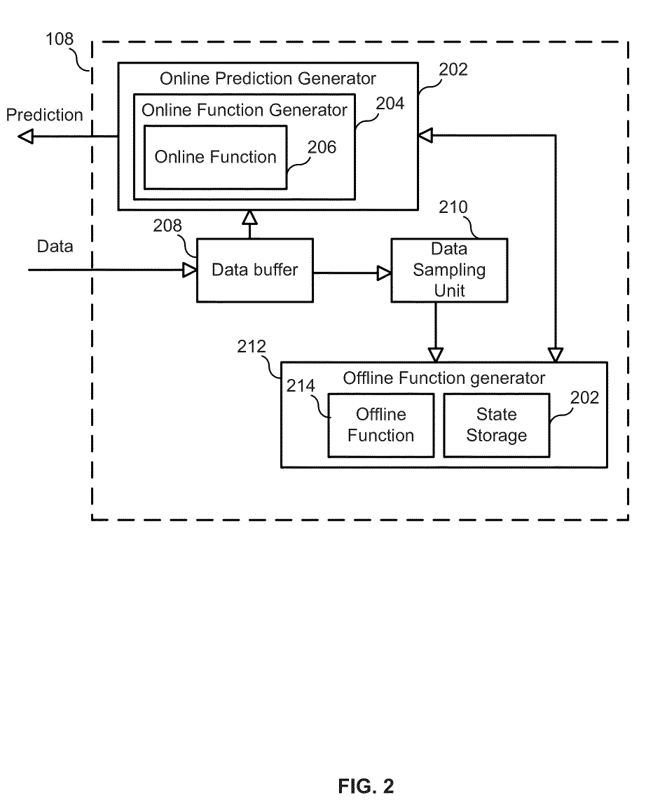

FIG. 2 illustrates an example of the predictive analytics system 108 that simultaneously performs online learning and offline learning. The system 108 may use an online function 206 to generate predictions, such as real-time predictions. An online function generator 204 may generate (e.g., update) the online function 206. As discussed below, the online function generator 204 may use online learning to update the online function 206 in certain instances, and may set the online function 206 as being equal to the offline function 214 in other instances.

The prediction analytics system 108 may further include an offline function generator 212 that uses offline learning to generate (e.g., update) an offline function 214. The updated offline function may be used to update the online function. In certain cases, the offline function generator 212 may include a state storage 202 that stores values of machine learning parameters used by the offline learning process to generate the offline function. By storing the machine learning parameter values, such values can be used for subsequent offline learning processes, which may speed up the offline learning.

In an embodiment, the online function and offline function may be any function (e.g., model) used to make a prediction, such as a regression model (e.g., linear regression model) or a machine learning function (e.g., a support vector machine).

In an embodiment, the prediction analytics system 108 includes a data buffer 208 for storing training data (e.g., user profile data and prediction feedback data). Such data may be used to perform online learning and offline learning, as described in more detail below. In an embodiment, the prediction analytics system 108 includes a data sampling unit 210, which may sample the training data to generate a particular set of training data, such as a set of training data having the least confidence values.

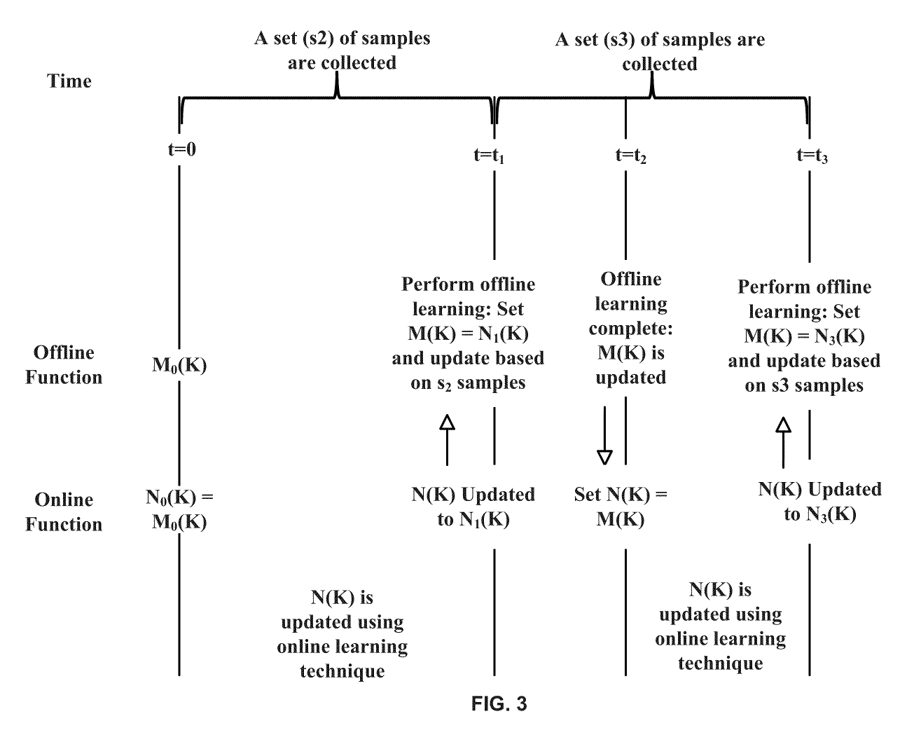

FIG. 3 shows a timing diagram that illustrates an online learning and offline learning process that takes place in parallel. In one example, the online function and offline function are used to generate a product recommendation based on user profile data. For instance, each function may be a support vector machine that classifies an input vector from the user profile data into a particular product category.

At time t=0, an offline function M₀(K) may be generated from a first set of training data. The training data may, for example, identify product recommendations previously adopted by users and the user profile data of those users. In one example, the function M₀(K) may be a support vector machine that defines boundaries between input vector values K so as to associate different sets of input vector values of a user profile with different product recommendations.

The offline function may be used to bootstrap the online function. More specifically, at time t=0, an online function N₀(K) may be set equal to the offline function M₀(K). The online function N₀(K) may then be used to make predictions that, e.g., a user with a particular user profile will adopt a particular product recommendation.

In the example shown in FIG. 3, online learning may be performed continuously to update the online function N(K). For instance, the online learning may rely on feedback data that indicates whether the prediction was correct (e.g., whether a particular product recommendation has been adopted). In some cases, the online learning may use fewer values of training data and a less complex computation compared to offline learning. As an example, the online learning may update N(K) between t=0 and t=t₁ as N₀(K)+λ*θ(K_{new}). K_{new} may refer to the most recent value or set of most recent values of the training data. λ refers to a lagrangian parameter, which can be used to weigh the recent trends compared to N(K). The online learning thus updates the online function with a linear term λ*θ(K_{new}).

In some implementations of θ(K_{new}), a clustering technique is used to obtain “Z” clusters and average prediction (using offline prediction) for each cluster. Given a new test point X, a value y*, based on the cluster to which X is mapped to, is determined. The number of clusters would depend on the expected performance (latency), since time taken to estimate the output using K_{new}, would increase with Z.

FIG. 3 further shows that the online function may be updated periodically using offline learning. The update may be performed at time t=t₁, after a sufficient number of samples of additional training data have been collected. The offline learning may perform the update on a snapshot of the online function. At time t=t₁, the snapshot of N(K) is N₁(K). The offline learning process may set an offline function M(K) equal to the snapshot and then perform the offline learning on M(K), so that N(K) remains available for making predictions.

While the offline learning occurs between t₁ and t₂, online learning and sampling of training data may be occurring as well, such as using the function λ*θ(K_{new}). When the offline learning is complete at t₂, the online function may be updated by setting it equal to the updated offline function. The simultaneous offline learning and online learning may be repeated, such as at t=t₃.

The process may repeat at time t=t₃, after a second set s₂ of samples have been collected. More specifically, the online function may be updated using offline learning based on the samples in s₂, and the offline learning may occur simultaneously with the online learning.

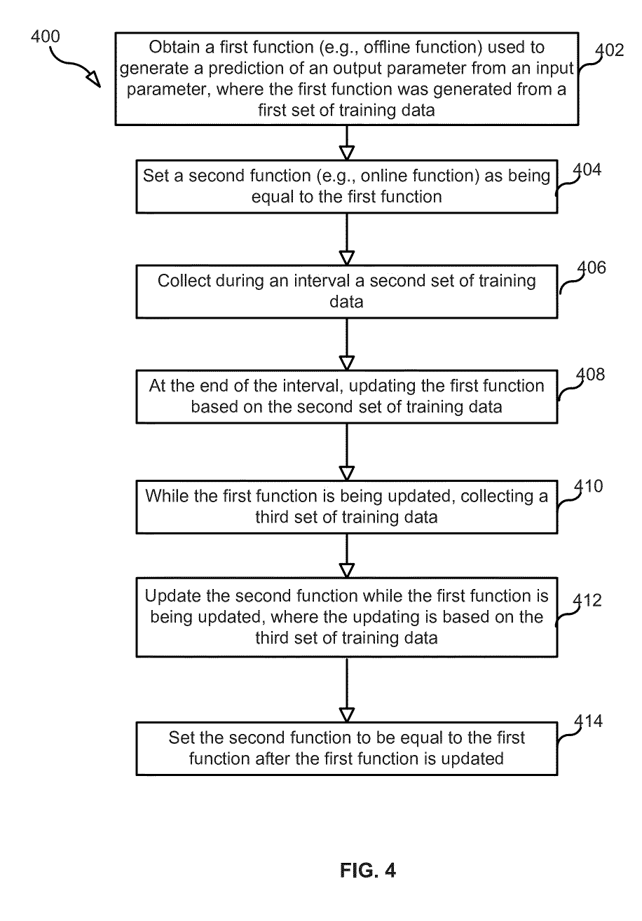

FIG. 4 is a flow diagram illustrating a process 400 performed by a predictive analytics system (e.g., predictive analytics system 108) for updating an online function used for making predictions.

In an embodiment, the process 400 begins at step 402, in which the predictive analytics system obtains a first function used to generate a prediction of an output parameter from an input parameter. The first function may have been generated from a first set of training data. For example, the first function may be an offline function generated from a set of training data that includes product recommendations previously adopted by users and those users' profile data. The users' profile data may be the input parameter values, while the data on whether the users adopted a product recommendation may be the output parameter values. The offline function may be, for instance, a support vector machine that classifies an input vector from a user's profile into a product recommendation.

In step 404, the predictive analytics system may set a second function as being equal to the first function, where the second function may be used to generate a prediction. For instance, the second function may be an online function that is bootstrapped with the offline function. The bootstrapping allows the online learning discussed below to start from a baseline state that is more accurate than without the bootstrapping. More specifically, beginning the online learning from a “cold start” may lead to initial online functions that are inaccurate because they are based on only a few values of training data.

In step 406, the predictive analytics system may collect during an interval a second set of training data. For example, the predictive analytics system 108 may receive data from the gateways 106a-n that can be used as training data. The training data may be labeled or unlabeled. For unlabeled data, a semi-supervised or unsupervised machine learning process may be used, while for labeled data a supervised machine learning process may be used. In some scenarios, the second set of training data may include feedback data on whether a prediction of the online function was correct.

In step 408, the predictive analytics system may update the first function based on the second set of training data. For example, the system may perform offline learning to update an offline function. As discussed below, the second set of training data may be a sample of all of the training data received by the predictive analytics system during the interval.

In step 410, the predictive analytics system may collect a third set of training data while the first function is being updated. As an example, while offline learning is taking place, sampling of training data may be simultaneously taking place. Because the offline learning takes time to complete, conducting the data sampling in parallel allows the predictive analytics system to capture changes in trends that may be missed by the offline learning.

At step 412, the predictive analytics system may update the second function while the first function is being updated, where the updating of the first function is based on the third set of training data. In some instances, the third set of training data is more recent than the second set of training data. As an example, online learning may be performed to update an online function while the offline learning is being performed on the offline function. Because the offline learning takes time, performing the online learning in parallel allows the online function to capture trends in data that may be missed by the offline learning. The online learning may be performed based on feedback data or based on the Lagrangian parameter that weighs recent trends in data, as described above.

In an embodiment, the process 400 includes step 414, in which the second function is set to be equal to the first function after the first function is updated. For instance, the online learning may be performed while the offline learning is taking place. If the online learning relies on fewer values of training data and less complex computations compared to the offline learning process, however, it may not be as accurate as the function generated by the offline learning process. Thus, after the offline function is completed by the offline learning, the online function may be set equal to the offline function.

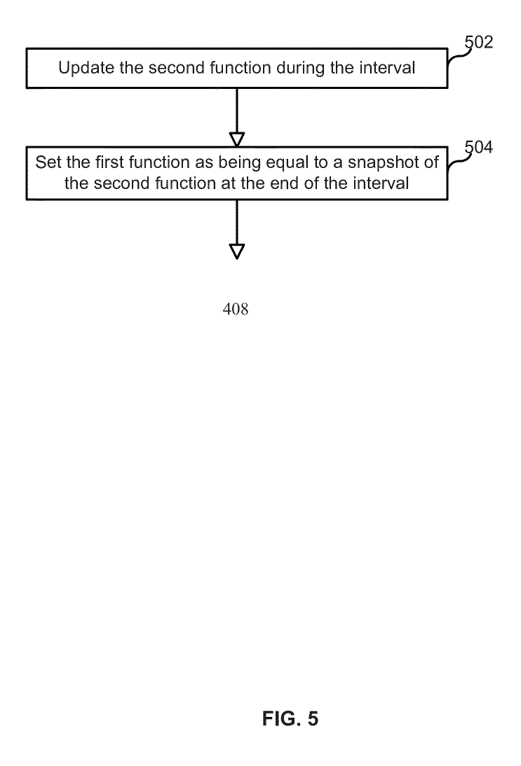

FIG. 5 provides a diagram which illustrates aspects of updating of the first function and second function. More particularly, at step 502, the second function may be updated during the interval in which the second set of training data is being collected. When the second set of training data is collected and the predictive analytics system is ready to perform offline learning, it may take a snapshot of the online function. Thus, in step 504, the system may set the first function (e.g., the offline function) as being equal to a snapshot of the second function (e.g., the online function) at the end of the interval. In the example, the offline learning is performed on the offline function only after a snapshot is taken of the online function.

As discussed above, the online learning process may be performed at a plurality of different time instances. In some cases, the online learning may be based on only a most recent value in a set of training data or a set of most recent values in the set of training data. For example, the online learning process may generate an updated online function N(K) by adding a previous snapshot to another function, e.g., λ*θ(K_{new}) that is based on one or more most recent values in the training data.

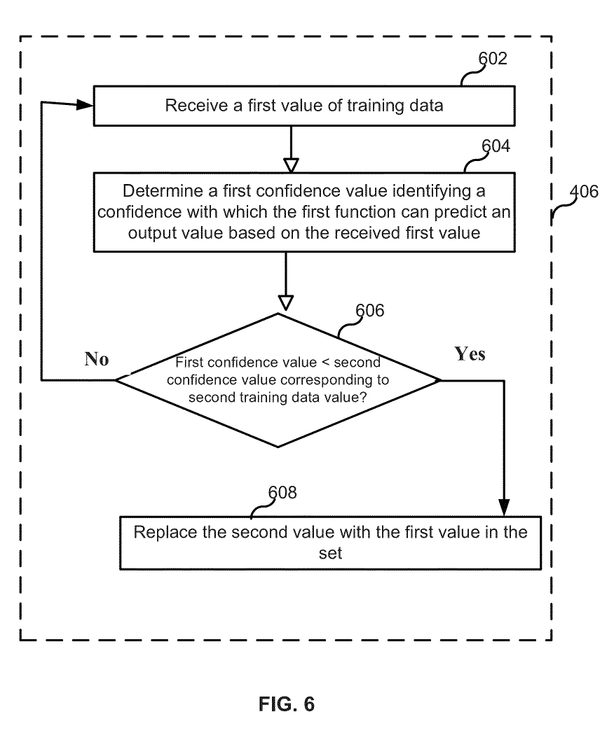

FIG. 6 illustrates an example of how a set of training data may be collected in step 406. As discussed above, the complete set of training data received during an interval may be too large to process with offline learning. Thus, the complete set of training data may need to be sampled to generate a smaller set of training data for the offline learning. The steps below show a least-confidence-based sampling. In one example, the confidence of a value of training data may be based on how close it is to a boundary of the offline function. For example, the offline function may be a support vector machine that defines boundaries separating input vector values into different classes. The confidence of a value (e.g., an input vector) of training data may depend on how close it is to a boundary defined by the offline function. An input vector that is close to the boundary may reflect less confidence, because it may be harder to classify. The input vector may also be a better training vector, however, because it allows the offline function to refine its boundary between classes.

In an embodiment, the collecting of a set of training data begins at step 602, in which the predictive analytics system receives a first value (e.g., a first input vector) of training data. In step 604, the predictive analytics system determines a first confidence value identifying a confidence with which the first function can predict an output value based on the received first value. For a function that defines boundaries to classify input data, the first confidence value may be determined, for instance, based on how close it is to one of the boundaries.

In step 606, a determination may be made as to whether the first confidence value is less than a second confidence value corresponding to a second training data value (e.g., a second input vector) that is already in the set. In response to determining that the first confidence value is less than a second confidence value, the first value of the training data may replace the second value of the training data in the set in step 608 (e.g., after an input vector is received, it may replace in the set of sampled training data another input vector that has a highest confidence value among the input vectors in the set). If the confidence value of the first input vector is not lower than that of any vectors already in the set, then it may be ignored.

The steps above may apply to a situation in which the set of training data has been completely filled. If the set is empty or is only partially filled, the first value may be placed in the set while skipping steps 604-608.

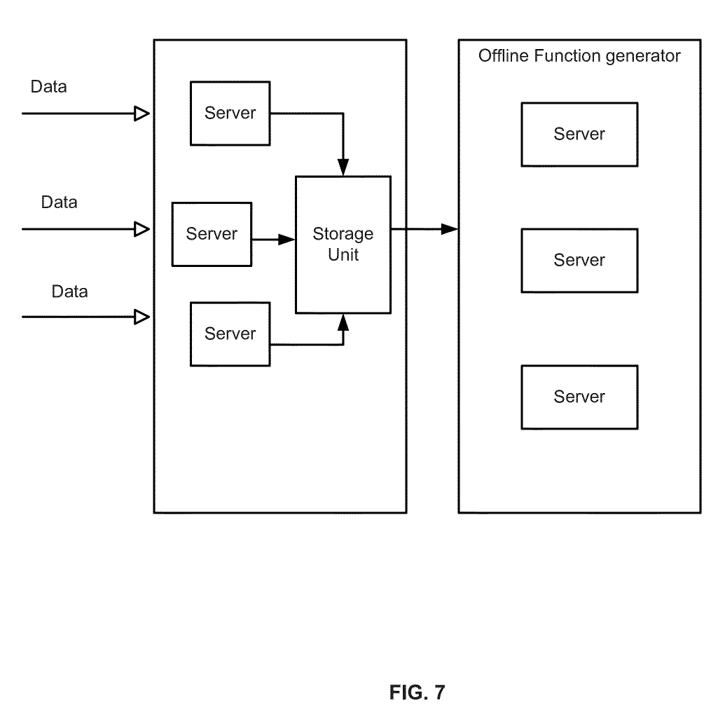

In an embodiment, the sampling of training data to collect the set of training data may be done in a distributed fashion. FIG. 6 illustrates a component (e.g., data sampling unit 210) for performing distributed sampling. The distributed sampling may use a real-time processing framework like Trident-Storm. The sampled training data may be stored in a common storage unit, such as a memcache. A plurality of servers may sample training data on a least-confidence basis and store the sampled data in a sorted fashion in the shared storage unit. The sampled training data may be fetched using a distributed remote procedure call (RPC) for further offline learning. As FIG. 7 illustrates, the offline learning may also be performed in a distributed fashion using a plurality of servers.

In an embodiment, the size of the intervals at which offline learning takes place may be determined by when the shared storage unit becomes full.

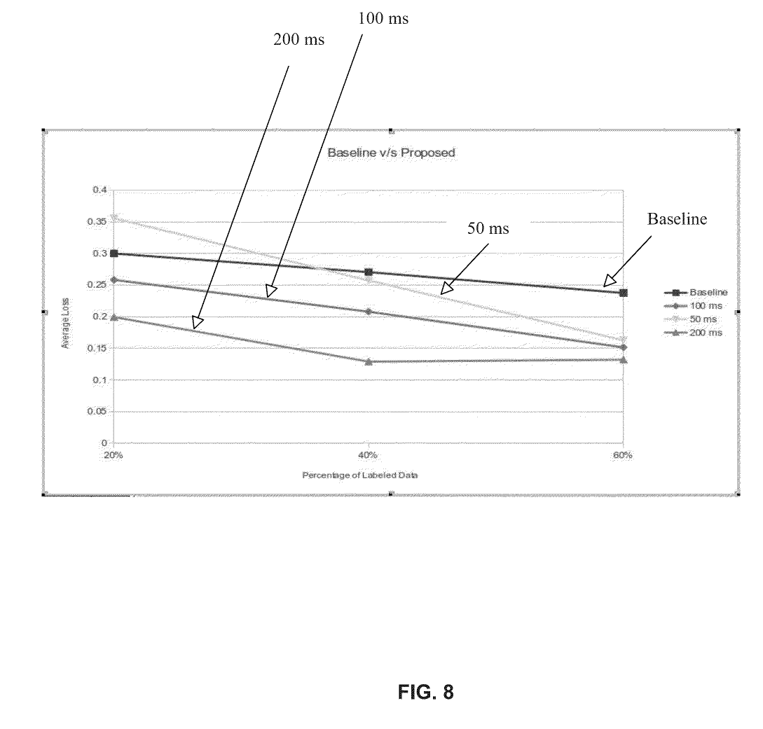

FIG. 8 illustrates experimental results from a dataset that includes a collection of labeled DNA sequences, each of which is 200 base pairs in length. The experiment used a sample of 12000 DNA sequences. Data is divided into labeled and unlabeled set using random sampling. Three sets are created with labeled ratio as 20%, 40%, and 60%.

In FIG. 8, X-axis is percentage of labeled data used; Y-axis is average loss across unlabeled data-points. The experiment uses 50 ms, 100 ms and 200 ms as the time intervals for moving from online to offline learning. The results show that a good choice of time interval (e.g., a higher interval) may yield a more effective result than the baseline online learning approach. Note that reduction in interval size can be modeled using a function of improvement in prediction performance (loss in this case), f(avg loss).

Exemplary Predictive Analytics System

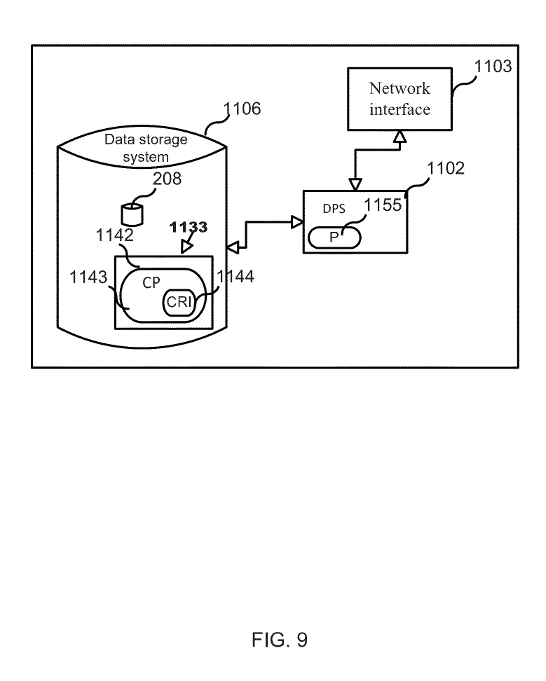

FIG. 9 illustrates a block diagram of a server used in the predictive analytics system 108. In an embodiment, the predictive analytics server may include a plurality of such servers. For example, the online prediction generator 202 may be implemented by a plurality of servers and the offline function generator 212 may be implemented by a plurality of servers. As shown in FIG. 9, each server may include: a data processing system (DPS) 1102, which may include one or more processors 1155 (e.g., a microprocessor) and/or one or more circuits, such as an application specific integrated circuit (ASIC), Field-programmable gate arrays (FPGAs), etc.; a transceiver 1103 for receiving message from, and transmitting messages to, another apparatus; a data storage system 1106, which may include one or more computer-readable data storage mediums, such as non-transitory data storage apparatuses (e.g., hard drive, flash memory, optical disk, etc.) and/or volatile storage apparatuses (e.g., dynamic random access memory (DRAM)). In embodiments where data processing system 1102 includes a processor (e.g., ranking processor 210), a computer program product 1133 may be provided, which computer program product includes: computer readable program code 1143 (e.g., instructions), which implements a computer program, stored on a computer readable medium 1142 of data storage system 1106, such as, but not limited, to magnetic media (e.g., a hard disk), optical media (e.g., a DVD), memory devices (e.g., random access memory), etc. In some embodiments, computer readable program code 1143 is configured such that, when executed by data processing system 1102, code 1143 causes the data processing system 1102 to perform steps described herein. In some embodiments, system 104 may be configured to perform steps described above without the need for code 1143. For example, data processing system 1102 may consist merely of specialized hardware, such as one or more application-specific integrated circuits (ASICs). Hence, the features of the present invention described above may be implemented in hardware and/or software.

In an embodiment, the components may refer to different pieces of computer-readable instructions on a non-transitory computer readable medium, and may be executed by the same processor, or by different processors.

While various aspects and embodiments of the present disclosure have been described above, it should be understood that they have been presented by way of example only, and not limitation. Thus, the breadth and scope of the present disclosure should not be limited by any of the above-described exemplary embodiments. Moreover, any combination of the elements described in this disclosure in all possible variations thereof is encompassed by the disclosure unless otherwise indicated herein or otherwise clearly contradicted by context.

Additionally, while the processes described herein and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method of updating functions used for making predictions by a predictive analytics system, the method comprising:
obtaining a first function used to generate a prediction of an output parameter from an input parameter, wherein the first function was generated from a first set of training data;
setting a second function as being equal to the first function, wherein the second function is used for generating a prediction;
collecting during an interval a second set of training data;
at the end of the interval, updating the first function based on the second set of training data; and
while the first function is being updated, collecting a third set of training data; and
updating the second function while the first function is being updated, wherein the updating of the second function is based on the third set of training data, and wherein the third set of training data is more recent than the second set of training data.

2. The method of claim 1, further comprising setting the second function equal to the first function after the first function is updated.

3. The method of claim 1, further comprising:
updating the second function during the interval;
setting the first function as being equal to a snapshot of the second function at the end of the interval, wherein the first function is updated after being set equal to the snapshot of the second function.

4. The method of claim 1, wherein updating the first function comprises using an offline machine learning algorithm, and wherein updating the second function comprises using an online machine learning algorithm.

5. The method of claim 4, wherein updating the second function comprises performing a plurality of updates corresponding to different time instances, and wherein each of the plurality of updates is based on only a most recent value in the third set of training data.

6. The method of claim 4, wherein updating the second function comprises adding to the second function another function that is based on one or more most recent values in the third set of training data.

7. The method of claim 5, wherein the another function includes a multiplier that identifies a trend in the third set of training data.

8. The method of claim 1, wherein collecting the second set training data comprises:
receiving a first value of training data during the interval;
determining a first confidence value identifying a confidence with which the first function can predict an output value based on the received first value;
determining whether the first confidence value is less than a second confidence value corresponding to a second value that is in the second set of training data; and
in response to determining that the first confidence value is less than the second confidence value, replacing the second value with the first value in the second set of training data.

9. The method of claim 8, wherein the first function defines a boundary between one or more classes, and wherein determining the first confidence value comprises determining a distance between the first value and the boundary.

10. The method of claim 8, wherein the second confidence value that is compared with the first confidence value is a highest confidence value for values in the second set of training data.

11. The method of claim 1, wherein a duration of the interval is dynamically determined.

12. The method of claim 10, wherein the duration of the interval equals a time taken for a storage size of the collected set of values to equal or exceed a buffer size allocated on a storage device to store the collected set of values.

13. The method of claim 12, wherein the collecting of the second set of training data is performed by a plurality of processors, and wherein the allocated buffer size is shared by the plurality of processors.

14. The method of claim 1, wherein updating the first function comprises calculating values of parameters of a machine learning algorithm, and wherein the method further comprises:
storing the values of the parameters in a storage device; and
performing another update of the first function using the stored values.

15. A predictive analytics system comprising one or more processors configured to:
obtain a first function used to generate a prediction of an output parameter from an input parameter, wherein the first function was generated from a first set of training data;
set a second function as being equal to the first function, wherein the second function is used for generating a prediction;
collect during an interval a second set of training data;
at the end of the interval, update the first function based on the second set of training data; and
while the first function is being updated, collect a third set of training data; and
update the second function while the first function is being updated, wherein the updating of the second function is based on the third set of training data, and wherein the third set of training data is more recent than the second set of training data.

16. The system of claim 15, wherein the one or more processors are further configured to set the second function equal to the first function after the first function is updated.

17. The system of claim 15, wherein the one or more processors are further configured to:
update the second function during the interval;
set the first function as being equal to a snapshot of the second function at the end of the interval, wherein the first function is updated after being set equal to the snapshot of the second function.

18. The system of claim 15, wherein the one or more processors are configured to update the first function by using an offline machine learning algorithm, and to update the second function by using an online machine learning algorithm.

19. The system of claim 18, wherein the one or more processors are configured to update the second function by performing a plurality of updates corresponding to different time instances, and wherein each of the plurality of updates is based on only a most recent value in the third set of training data.

20. The system of claim 18, wherein the one or more processors are configured to update the second function by adding to the second function another function that is based on one or more most recent values in the third set of training data.

21. The system of claim 19, wherein the another function includes a multiplier that identifies a trend in the third set of training data.

22. The system of claim 15, wherein the one or more processors are configured to collect the second set training data by:
receiving a first value of training data during the interval;
determining a first confidence value identifying a confidence with which the first function can predict an output value based on the received first value;
determining whether the first confidence value is less than a second confidence value corresponding to a second value that is in the second set of training data; and
in response to determining that the first confidence value is less than the second confidence value, replacing the second value with the first value in the second set of training data.

23. The system of claim 22, wherein the first function defines a boundary between one or more classes, and wherein the one or more processors are configured to determine the first confidence value by determining a distance between the first value and the boundary.

24. The system of claim 22, wherein the second confidence value that is compared with the first confidence value is a highest confidence value for values in the second set of training data.

25. The system of claim 15, wherein a duration of the interval is dynamically determined.

26. The system of claim 24, wherein the duration of the interval equals a time taken for a storage size of the collected set of values to equal or exceed a buffer size allocated on a storage device to store the collected set of values.

27. The system of claim 26, wherein the collecting of the second set of training data is performed by a plurality of processors, and wherein the allocated buffer size is shared by the plurality of processors.

28. The system of claim 15, wherein the one or more processors are configured to update the first function by calculating values of parameters of a machine learning algorithm, and wherein the method further comprises:
storing the values of the parameters in a storage device; and
performing another update of the first function using the stored values.
